(19) United States
(12) Patent Application Publication
(10) Pub. No.: US 2008/0259308 A1
(43) Pub. Date: Oct. 23, 2008

(54) PROJECTION OBJECTIVE FOR MICROLITHOGRAPHY

(75) Inventor: Alexander Epple, Aalen (DE)

Correspondence Address: FISH & RICHARDSON PC, P.O. BOX 1022, MINNEAPOLIS, MN, 55440-1022, US

(73) Assignee: CARL ZEISS SMT AG, Oberkochen (DE)

(21) Appl. No.: 12/104,091

(22) Filed: Apr. 16, 2008

(30) Foreign Application Priority Data
Apr. 18, 2007 (DE) 10 2007 020 307.3

(51) Int. Cl. G03B 27/72

(52) U.S. Cl. 355/71

(57) ABSTRACT

A projection objective or microlithography for imaging a pattern arranged in an object plane on a substrate arranged in an image plane is disclosed. The projection objective has an arrangement of optical elements between the object plane and the image plane. The projection objective can have a first pupil plane arranged at the reticle side and at least a second pupil plane. The projection objective also includes at least one aperture diaphragm. The diaphragm aperture of which is variable and which is traversed only once by the imaging light. The at least one aperture diaphragm can be arranged within the arrangement of the optical elements at least optically close to the first pupil plane arranged at the reticle side. The projection objective further includes a pupil filter situated in immediate vicinity of the aperture diaphragm.

### CROSS-REFERENCE TO RELATED APPLICATION

This application claims under 35 U.S.C. § 119 the benefit of German patent application 10 2007 020 307.3, filed Apr. 18, 2007, which is hereby incorporated by reference.

### FIELD

The disclosure relates to a projection objective for microlithography that can, for example, be used to image a pattern arranged in an object plane on a substrate arranged in an image plane.

### BACKGROUND

A projection objective can be used as part of the microlithographic production of semi-conductors in which an object provided with a pattern, which is also called reticle, is imaged on a substrate, which is called wafer, via the projection objective. In general, the reticle is arranged in an object plane of the projection objective and the wafer is arranged in an image plane of the projection objective. Typically, the wafer is provided with a photosensitive layer during the exposure of which via light the pattern of the reticle is transferred through the projection objective onto the photosensitive layer. After development of the photosensitive layer, the desired pattern can be produced on the wafer, the process of exposure being repeated several times, if desired.

Various designs of projection objectives are known which can be divided into three classes. A first class relates to dioptric designs in which the projection objective only has refractive elements. A second class of projection objectives is formed by the catoptric projection objectives which are only constructed of reflective elements. A third class of projection objectives is the catadioptric projection objectives, the optical arrangement of optical elements of which has both refractive and reflective elements.

### SUMMARY

The present disclosure relates to, in particular, dioptric and catadioptric projection objectives.

In some embodiments, the disclosure provides a projection objective for microlithography having improved imaging properties.

In certain embodiments, the disclosure provides a projection objective for microlithography for imaging a reticle arranged in an object plane on a wafer arranged in an image plane, including an arrangement of optical elements between the object plane and the image plane, wherein the arrangement has a first pupil plane arranged at the reticle side and at least a second pupil plane, and at least one aperture diaphragm, the diaphragm aperture of which is variable and which is traversed only once by the imaging light, wherein the at least one aperture diaphragm is arranged within the arrangement of the optical elements at least optically close to the first pupil plane arranged at the reticle side, and wherein a pupil filter is situated in immediate vicinity of the aperture diaphragm.

In some embodiments, the aperture diaphragm is in the part of the objective at the reticle side, such as in the relay system of the projection objective. Typically, the diaphragm position is selected in such a manner that the imaging light traverses the diaphragm aperture of the aperture diaphragm only once. A diaphragm position for the aperture diaphragm at which the light traverses the aperture diaphragm only once can have the advantage that the aperture diaphragm has no vignetting effect by a double light passage. Another advantage of the arrangement of the aperture diaphragm in the part of the objective close to the reticle can be that the value of the curvature of the aperture diaphragm can be varied within relatively large limits which is not the case in the part of the objective close to the wafer as described above.

The term “at least optically close to the pupil plane” is to be understood here that the absolute value of the ratio of the height of the principal ray to the height of the margin ray at an optical surface is smaller than 0.2.

In the sense of the present disclosure, “at least optically close to the pupil plane” also includes a choice of diaphragm position directly in the pupil plane. Arranging the aperture diaphragm in or close to a pupil plane can have the advantage that a pupil filter can be arranged at the diaphragm position or in its immediate vicinity which, with maximum numeric aperture, shades the central pupil in order to remove the zero order diffraction out of the path of the image rays. In addition, the choice of the diaphragm position in or close to a pupil plane opens the possibility of attaching a further correction element in immediate vicinity to the pupil which, for example by aspherization can correct aberrations which can arise, for instance, by service life effects (lens heating, compacting) and which have typically a constant-field variation.

In some embodiments, the Petzval sum is undercorrected between the object plane and the aperture diaphragm plane.

Optionally, the diaphragm aperture is variable on a curved surface which can be concave towards the object plane.

This can have the advantage that the correction of the diaphragm function is facilitated since it meets the naturally occurring Petzval curvature of the entry pupil through the first group of optical elements between reticle and aperture diaphragm.

In certain embodiments, the aperture diaphragm is positioned immediately between two refractive elements of the optical elements.

With such an arrangement of the aperture diaphragm, the diaphragm can advantageously be considered in the optic design of the projection objective with low expenditure, because there is a larger degree of freedom in terms of design with respect to the configuration of the adjacent refractive optical elements rather than with an adjacent mirror.

The diaphragm position can be at least optically close to the pupil plane closest to the reticle side.

Advantages of this embodiment can be obtained from the advantages of the projection objective according to the disclosure in conjunction with the advantages of a diaphragm position in or close to a pupil plane.

Since such a pupil filter is not required for every application, the pupil filter is removable according to certain embodiments.

In particular, the pupil filter generally has a smaller diameter than the aperture diaphragm. If the diaphragm plane is curved, the diaphragm plane and the plane in which a pupil filter is as effective as possible, are axially spaced from one another. This allows to use both elements in the objective at the same time.

Therefore, the pupil filter can be arranged within the cavity spanned by the curved surface.

When a pupil filter is provided, the curvature of the surface along which the diaphragm aperture of the aperture diaphragm is variable can be selected in such a manner that a mechanical separation between the aperture diaphragm and the pupil filter is possible whereas the curvature of the surface generally should not be so great that installation space conflicts arise between the mounting of the aperture diaphragm and the optical elements surrounding it.

Optionally, the relation 0.5<|h/r|<0.1 applies to the curved surface, where h is half the diameter of the aperture diaphragm with a full numeric aperture and r is the radius of the curved surface. If the upper limit is violated the diaphragm surface may be curved too weakly for mounting the pupil filter and the aperture diaphragm with sufficient mechanically distance. If the lower limit is violated the curvature of the diaphragm may be too strong which can negatively effect the use of an aperture diaphragm which is variable in size.

In some embodiments, the projection objective is a catadioptric projection objective, the arrangement of optical elements of which has at least one concave mirror.

In certain embodiments, the projection objective is a dioptric projection objective. In such embodiments, the advantages disclosed herein can also be utilized.

In some embodiments, the projection objective has at least one intermediate image.

Further advantages and features are obtained from the subsequent description and the attached drawing.

Naturally, the features mentioned above and still to be explained in the text which follows can be used not only in the combination specified in each case but also in other combinations or by themselves without departing from the context of the present disclosure.

### BRIEF DESCRIPTION OF THE DRAWINGS

Exemplary embodiments of the disclosure are shown in the drawing and will be described in greater detail hereinafter with reference to the drawing, in which:

FIG. 1 shows an exemplary embodiment of a projection objective in an overall representation;

FIG. 2 shows an enlarged representation of the part of the lens at the wafer side of the projection objective in FIG. 1 for illustrating the problem forming the basis of the disclosure;

FIG. 3 shows the last lens element of the projection objective in FIG. 1 in a diagrammatic representation;

FIG. 4 shows an enlarged representation of a section at the reticle side of the projection objective in FIG. 1 with a diaphragm arrangement and a pupil filter;

FIG. 5 shows a diagram which shows the relation between the principal-ray angle and the numeric aperture when stopped down by an ideal spherical diaphragm function;

FIGS. 6 to 10 show exemplary embodiments of projection objectives in which a diaphragm arrangement can be used.

### DETAILED DESCRIPTION

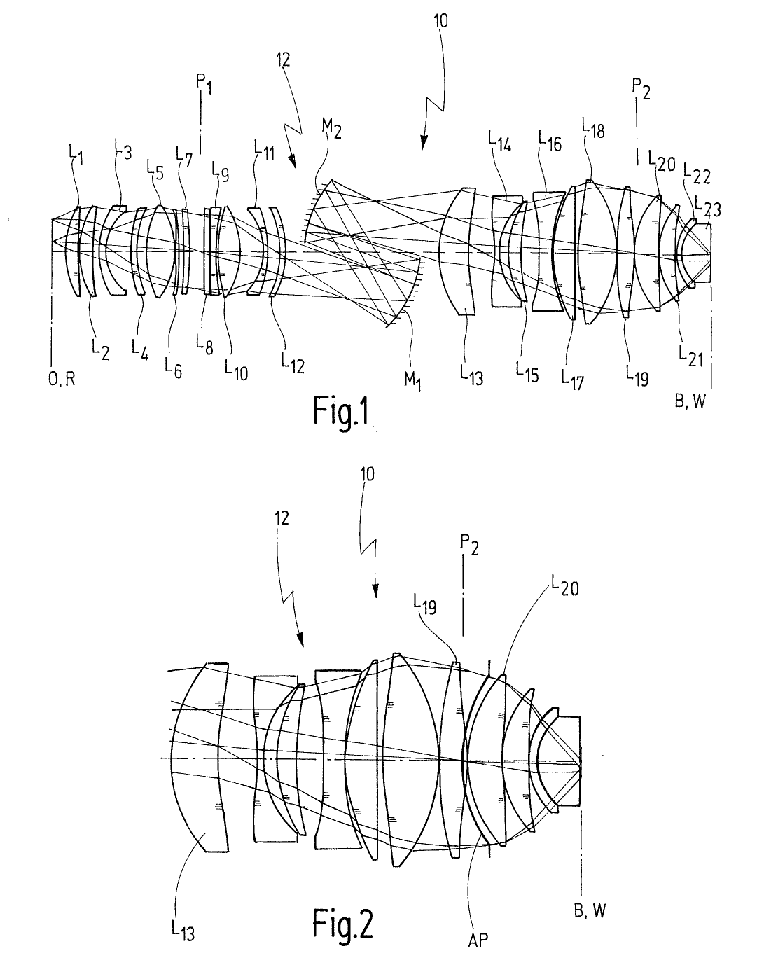

FIG. 1 shows a projection objective for microlithography provided with the general reference symbol 10. The projection objective 10 is used for imaging a reticle R, arranged in an object plane O, on a wafer W arranged in an image plane B.

The projection objective 10 has an arrangement 12 of a plurality of optical elements. These optical elements include, beginning from the object plane O, lenses L₁ to L₁₂ which form an optical relay system of the projection objective 10. The lenses L₁ to L₁₂ also include a correction element L₈ which, for example, can be arranged in the form of a plane-parallel plate with correction aspheres mounted thereon. A pupil plane P₁ is located between optical element L₇ and optical element L₈.

The arrangement 12 also has a first concave mirror M₁ and a second concave mirror M₂.

Seen in the direction of the optical path, the concave mirror M₂ is followed by a further group of lenses L₁₃ to L₂₃.

Overall, the projection objective 10 is catadioptric due to the fact that it has both refractive optical elements (particularly lenses) and reflective optical elements (in this case mirrors M₁ and M₂).

In the present description, the group of optical elements L₁ to L₁₂ is also called the objective part at the reticle side of the projection objective 10 whilst the group of optical elements L₁₃ to L₂₃ is called the objective part at the wafer side.

In the objective part at the wafer side, a further pupil plane P₂ is located between element L₁₉ and element L₂₀.

In the text which follows, it is described which position within the arrangement 12 is suitable for the arrangement of an aperture diaphragm and which is not, i.e. it is described which diaphragm position is optimal within the arrangement 12.

Firstly, FIG. 2 shows the case where an aperture diaphragm AP is located in the immediate vicinity of the pupil plane P₂. Such a diaphragm position for the aperture diaphragm AP is found to often be disadvantageous, for the following reasons.

The projection objective 10 has a very high numeric aperture and in addition, the last optical element L₂₃ has a very high refractive power. The last optical element L₂₃ is a convex plane lens, the convex front of which is essentially curved concentrically around the wafer arranged in the image plane B. However, this leads to a strong diaphragm curvature of the aperture diaphragm AP, the diaphragm surface towards the image plane B or towards the wafer W, respectively, being hollow as can be seen from FIG. 2.

FIG. 2 shows how the aperture diaphragm AP in the projection objective 10 is arranged for having a diaphragm aperture with a variable size in order to be able to selectively set the numeric aperture without departing from the specification with respect to the telecentricity of the imaging. It can already be seen from FIG. 2 that the aperture diaphragm AP is in installation space conflict with the adjoining optical elements L₁₉ and L₂₀ due to its required strong curvature. When the aperture diaphragm AP is fully opened, i.e. when its diaphragm leaves are moved out of the optical path, the installation space conflict with the mounting of the adjoining optical elements L₁₉ and L₂₀ can be insurmountable. This holds for conventional diaphragm apertures the leaves of which are shaped as sphere segments.

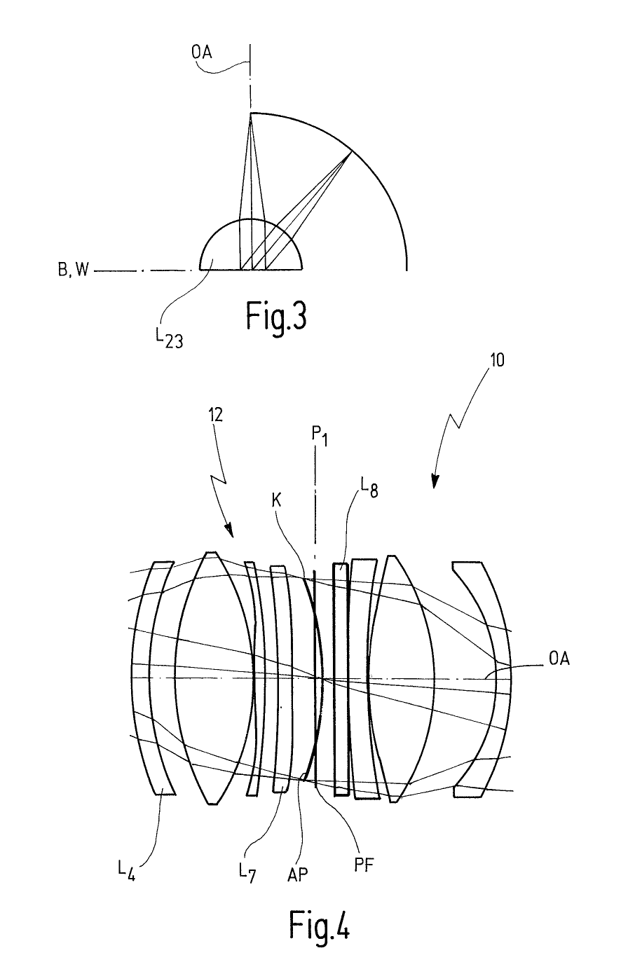

FIG. 3 shows how the strong curvature of the aperture diaphragm AP is arrived at. In FIG. 3, the last optical element L₂₃ is shown simplified as a hemisphere. It can be seen that the light beam of the axial point is focused onto the optical axis OA. For reasons of symmetry, however, the edge of the exit pupil must be imaged onto a concentric circle around the wafer W. If there were no further optical elements between the last optical element L₂₃ and the aperture diaphragm AP, particularly lens elements, the ideal aperture diaphragm AP would be concentric around the wafer B of necessity. The curvature of the surface on which the diaphragm aperture of the aperture diaphragm AP can be varied is essentially given by the Petzval sum of the last optical element L₂₃ since there is no astigmatism in the pupil image for reasons of symmetry. However, the Petzval sum at the diaphragm position of the aperture diaphragm AP according to FIG. 2 is greatly over-corrected.

It would then be possible to attempt to correct this effect by introducing a strong astigmatism in the pupil image with the optical elements between the last optical element L₂₂ and the diaphragm plane of the aperture diaphragm AP, i.e. to level out the tangential shell of the pupil image. However, experience shows that this can often be difficult to achieve.

FIG. 4 then shows the projection objective 10 in which the aperture diaphragm AP is not arranged in the objective part at the wafer side but in the objective part at the reticle side in or in the immediate vicinity of the pupil plane P₁ between optical elements L₇ and L₈. FIG. 4 already shows that there is no installation space conflict between the aperture diaphragm AP and the adjacent optical elements in the objective part at the reticle side of the projection objective 10.

According to the disclosure, the aperture diaphragm AP is arranged at a diaphragm position at which the Petzval sum of the optical elements L₁ to L₇ is undercorrected seen from reticle R. In particular, the aperture diaphragm AP is located between two refractive elements, in this case optical elements L₇ and L₈, and is traversed by light only once. The diaphragm aperture of the aperture diaphragm is variable along a curved surface which is hollow towards the reticle R.

Arranging the aperture diaphragm AP in the area of the pupil plane P₁ in the objective part at the reticle side of the projection objective 10 also makes it possible to provide a pupil filter PF in the aperture position which, with maximum numeric aperture, i.e. with the fully opened aperture diaphragm AP, shades the central pupil in order to remove the zero order diffraction out of the path of the image rays if this is desirable for the imaging process to be performed.

The aperture diaphragm AP is designed as spherical diaphragm with distinct bending. When the aperture diaphragm AP is fully open, the pupil filter PF can then be pushed in with sufficient distance from the diaphragm leaves of the aperture diaphragm AP. FIG. 4 shows an exemplary plane for the pupil filter PF at about 70% of the full numeric aperture of the projection objective. In principle, other numeric apertures of the pupil filter could also be implemented by shifting the position of the pupil filter PF in the direction of the optical axis OA, and by changing the size of the pupil filter.

If the pupil diameter is selected to be large enough, a correction element as in this case the optical element L₈ can also be installed sufficiently close to the pupil, which, via aspherization can correct aberrations which, for instance, arise from service life effects (compactification) or effects of heating of the lens material during the operation of the projection objective 10.

As can be seen from FIG. 4, the aperture diaphragm AP is concave towards the object plane O and towards the reticle. This facilitates the correction of the diaphragm function since it accommodates the naturally occurring Petzval curvature of the entry pupil by the first lens group L₁ to L₇. The magnitude of the curvature of the aperture diaphragm AP can be varied within relatively large limits in the objective part at the reticle side of the projection objective 10. Whilst a greater curvature has a favourable effect on the mechanical separation of aperture diaphragm AP and pupil filter PF, the greater curvature increases the demands on the design of the spherical diaphragm and more quickly creates installation space conflicts between the mounting of the aperture diaphragm AP and the optical elements surrounding it.

The curvature can be selected in such a manner that the relation 0.5<|h/r|<0.1 applies to the curved surface of the aperture diaphragm AP, where h is half the diameter of the aperture diaphragm AP with full numeric aperture and r is the radius of the curved surface of the aperture diaphragm AP.

In the exemplary embodiment shown, the curvature of the aperture diaphragm AP was set to a value of 1/r=1/250 mm. Half the diameter h of the aperture diaphragm AP would be 78.1 mm. Assuming that the pupil filter PF just fills out the entire aperture at a numeric aperture of 1.1, the pupil filter PF can be inserted as a level plane at an axial distance of 7.2 mm behind the light-limiting edge K of the fully opened aperture diaphragm AP. This allows for mechanically mounting both elements in the beam path.

If then the projection objective 10 is stopped down from the maximum numeric aperture to smaller numeric apertures, the spherical aperture diaphragm AP must follow a course which is, in good approximation, spherical. In the case of an ideal correction of the diaphragm function to a spherical shell, there would be no telecentricity error at the wafer W over the entire aperture range. Due to smaller and acceptable residual errors, however, the principal-ray angle at the wafer deviates slightly from the telecentric direction with stopping-down.

In table 2 the system data of the projection objective 10 in FIG. 4 are listed.

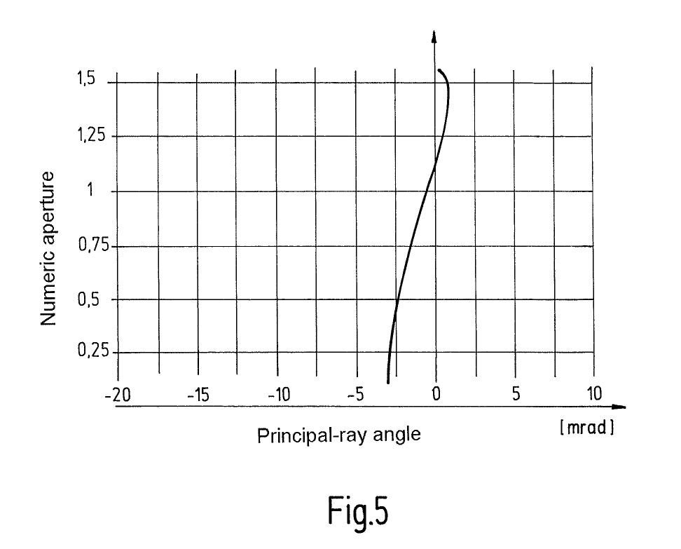

FIG. 5 shows a diagram in which the principal-ray angle is related to the numeric aperture. FIG. 5 shows the principal-ray angle resulting with stopping-down by the ideal spherical diaphragm function. FIG. 5 shows that the deviation is only minimal and is below 1 mrad within the range of numerical apertures of between 0.90 and 1.55 in the present example. This situation is also represented in the following table 1.

TABLE 1

| | | Telecentricity |
|---|---|---|
| | Aperture diaphragm | at the wafer |
| Numeric aperture | diameter [mm] | [mrad] |
| 1.55 | 155.35 | 0.21 |
| 1.51 | 149.92 | 0.65 |
| 1.47 | 144.33 | 0.85 |
| 1.42 | 138.54 | 0.91 |
| 1.37 | 132.46 | 0.84 |
| 1.32 | 125.95 | 0.70 |
| 1.25 | 118.82 | 0.48 |
| 1.18 | 110.66 | 0.19 |
| 1.08 | 100.42 | −0.20 |
| 0.85 | 77.11 | −1.15 |

TABLE 2
NA 1.55
OBH 66.5
Wavelength 193.3

REFRACTIVE

| | | | | | SEMI- |
|---|---|---|---|---|---|
| | RADIUS | THICKNESS | MATERIAL | INDEX | DIAM. |
| 0 | 0.000000 | 30.199776 | | | 66.5 |
| 1 | 201.491308 | 25.668971 | SILUV | 1.560364 | 87.6 |
| 2 | 1236.256906 | 0.999895 | | | 88.1 |
| 3 | 172.377339 | 29.078421 | SILUV | 1.560364 | 91.7 |
| 4 | 559.975561 | 13.127379 | | | 90.4 |
| 5 | 170.703295 | 15.928233 | SILUV | 1.560364 | 87.2 |
| 6 | 106.032446 | 48.848781 | | | 79.6 |
| 7 | 186.698511 | 11.917466 | SILUV | 1.560364 | 84.9 |
| 8 | 190.269116 | 22.249404 | | | 85.1 |
| 9 | 222.328079 | 59.677014 | SILUV | 1.560364 | 92.9 |
| 10 | −176.121666 | 1.350327 | | | 93.3 |
| 11 | 664.209452 | 8.041381 | SILUV | 1.560364 | 85.2 |
| 12 | −518.774706 | 10.067606 | | | 84.8 |
| 13 | −792.570514 | 9.999886 | SILUV | 1.560364 | 82.4 |
| 14 | 637.728061 | 11.000851 | | | 81.4 |
| 15 | 0.000000 | 22.380074 | | | 77.7 |
| 16 | 0.000000 | 10.000000 | SILUV | 1.560364 | 82.8 |
| 17 | 0.000000 | 0.999691 | | | 84.3 |
| 18 | 876.109163 | 13.799798 | SILUV | 1.560364 | 85.2 |
| 19 | 524.346364 | 0.999669 | | | 87.4 |
| 20 | 225.223535 | 50.055286 | SILUV | 1.560364 | 89.8 |
| 21 | −172.128514 | 49.313262 | | | 90.7 |
| 22 | −122.611198 | 9.999918 | SILUV | 1.560364 | 81.3 |
| 23 | −179.799762 | 25.712157 | | | 85.6 |
| 24 | −198.093556 | 10.999919 | SILUV | 1.560364 | 86.6 |
| 25 | −226.255136 | 287.679680 | | | 88.7 |
| 26 | −195.777654 | −247.679748 | REFL | | 154.3 |
| 27 | 204.547591 | 287.679547 | REFL | | 145.4 |
| 28 | 201.259105 | 64.762666 | SILUV | 1.560364 | 128.3 |
| 29 | 288.146973 | 54.723056 | | | 121.4 |
| 30 | −381.425709 | 10.001661 | SILUV | 1.560364 | 111.8 |
| 31 | 133.082606 | 17.873163 | | | 99.9 |
| 32 | 148.292612 | 28.476807 | SILUV | 1.560364 | 101.7 |
| 33 | 396.599141 | 38.300442 | | | 101.9 |
| 34 | −2009.447123 | 29.276836 | SILUV | 1.560364 | 104.9 |
| 35 | 317.489701 | 1.397574 | | | 120.0 |
| 36 | 193.990317 | 44.622458 | SILUV | 1.560364 | 132.9 |
| 37 | 8453.282230 | 8.773806 | | | 135.2 |
| 38 | 336.634800 | 80.605801 | SILUV | 1.560364 | 143.9 |
| 39 | −224.451862 | 0.999648 | | | 146.2 |
| 40 | 578.602979 | 37.975699 | SILUV | 1.560364 | 132.6 |
| 41 | −424.640191 | 0.999544 | | | 130.1 |
| 42 | 174.628423 | 49.373790 | SILUV | 1.560364 | 116.8 |
| 43 | 378.132377 | 0.999336 | | | 113.5 |
| 44 | 147.616148 | 35.793710 | SILUV | 1.560364 | 96.0 |
| 45 | 951.402921 | 0.998410 | | | 91.4 |
| 46 | 100.642991 | 10.015425 | SILUV | 1.560364 | 69.4 |
| 47 | 77.836441 | 0.998441 | | | 59.5 |
| 48 | 75.953835 | 60.000000 | LUAG | 2.143500 | 58.7 |
| 49 | 0.000000 | 3.000000 | HIINDEX | 1.650000 | 24.8 |
| 50 | 0.000000 | 0.000000 | | | 16.6 |

ASPHERIC CONSTANTS

| | SURFACE | | | | |
|---|---|---|---|---|---|
| | 2 | 7 | 11 | 14 | 18 |
| K | 0 | 0 | 0 | 0 | 0 |
| C1 | 1.955297E−08 | −1.052393E−07 | −1.846723E−07 | −1.920096E−07 | −1.166123E−08 |
| C2 | 2.178029E−13 | 4.002697E−12 | −6.904796E−12 | −4.624738E−12 | −6.299110E−12 |
| C3 | −4.638773E−17 | −2.409948E−16 | 4.146098E−16 | 8.065151E−16 | 7.617780E−16 |
| C4 | 6.102663E−21 | 2.300946E−21 | −6.083375E−20 | −2.330024E−20 | 2.852927E−20 |
| C5 | −2.632406E−25 | 6.783855E−25 | 9.333315E−24 | 3.938255E−24 | −1.720078E−23 |
| C6 | 7.768753E−30 | −3.835222E−28 | −6.483174E−28 | −4.207936E−29 | 2.559102E−27 |
| C7 | −4.818615E−34 | 2.078038E−32 | 4.575745E−32 | 1.774749E−33 | −1.322014E−31 |
| | SURFACE | | | | |
| | 20 | 23 | 25 | 26 | 27 |
| K | 0 | 0 | 0 | −1.870120 | −2.480440 |
| C1 | −8.581142E−08 | 1.105549E−07 | −4.125313E−08 | −2.452211E−08 | 3.066902E−08 |
| C2 | 6.942284E−12 | −3.087252E−12 | 1.388182E−12 | 8.446814E−14 | −3.220462E−13 |
| C3 | −1.055376E−15 | −3.356971E−16 | −6.616346E−17 | −3.051648E−18 | 8.839445E−18 |
| C4 | 8.246073E−20 | −2.066676E−20 | 1.461794E−20 | 2.885184E−23 | −1.881411E−22 |
| C5 | −2.357832E−24 | 2.577210E−24 | −9.286742E−25 | −6.429793E−28 | 3.996867E−27 |
| C6 | −2.051522E−28 | −1.470732E−28 | 1.135317E−28 | 6.948971E−33 | −5.761078E−32 |
| C7 | 1.356079E−32 | 5.165101E−33 | −5.602750E−33 | −9.485609E−38 | 4.228188E−37 |
| | SURFACE | | | | |
| | 29 | 30 | 32 | 34 | 36 |
| K | 0 | 0 | 0 | 9.999600 | 0 |
| C1 | −8.170894E−08 | 1.141742E−07 | −6.514330E−08 | −1.748012E−08 | −6.044130E−08 |
| C2 | 1.489639E−12 | −1.442135E−12 | −5.221529E−14 | −5.121827E−12 | 2.225525E−13 |
| C3 | 8.233579E−17 | 1.345615E−17 | −7.682607E−17 | −9.439613E−17 | 1.568982E−16 |
| C4 | −3.657373E−21 | −5.051696E−21 | −5.785844E−22 | 2.420173E−20 | −2.229053E−20 |
| C5 | −2.622221E−25 | 2.624523E−25 | −5.792299E−25 | −1.265870E−24 | 1.405006E−24 |
| C6 | 1.828498E−29 | −1.489393E−29 | 3.834808E−29 | 8.092902E−29 | −4.702887E−29 |
| C7 | −3.021413E−34 | 4.275450E−34 | −2.724007E−33 | −5.474989E−34 | 6.632843E−34 |

SURFACE

| | 38 | 41 | 43 | 45 |
|---|---|---|---|---|
| K | 0 | 0 | 0 | 0 |
| C1 | −9.549827E−08 | 2.390095E−08 | −1.083477E−07 | −1.945643E−08 |
| C2 | 4.207262E−12 | 2.279400E−13 | 3.804657E−12 | 7.967785E−12 |
| C3 | −9.857131E−17 | 4.829679E−17 | 5.525078E−17 | −2.097149E−16 |
| C4 | 2.642820E−21 | −1.737626E−21 | −3.858192E−20 | −9.153480E−21 |
| C5 | −2.222810E−25 | 5.030890E−26 | 4.116474E−24 | 1.673113E−24 |
| C6 | 1.027328E−29 | −2.431432E−31 | −1.910100E−28 | −4.672091E−29 |
| C7 | −1.641520E−34 | −4.944157E−35 | 3.531666E−33 | −1.201004E−33 |

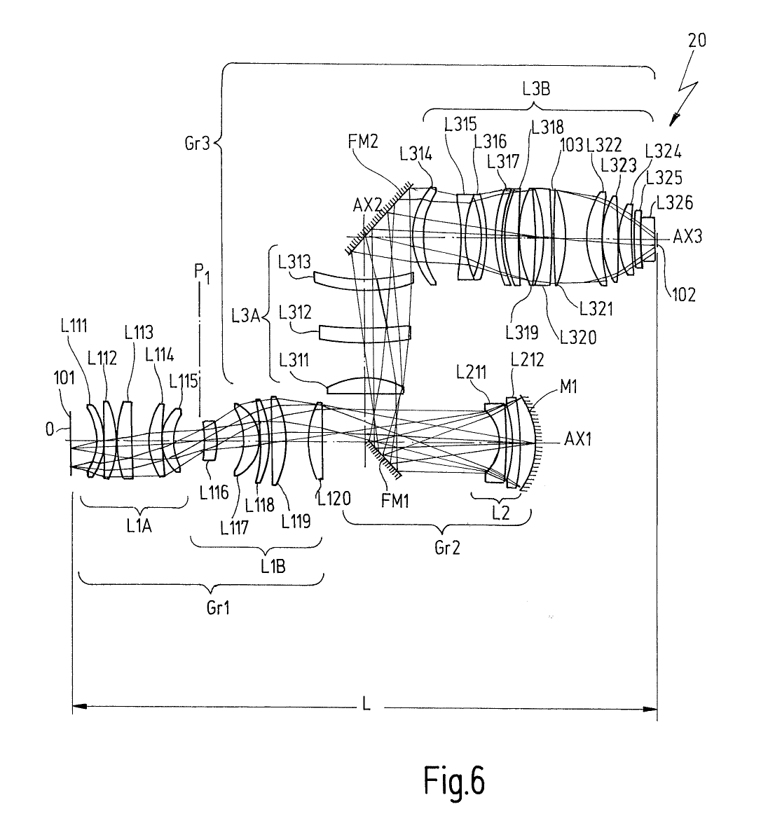

FIGS. 6 to 9 show further exemplary embodiments of projection objectives, which also have at least one intermediate image plane, i.e. which also have a pupil plane P₁ at the reticle side, and in which the disclosure can also be used.

FIG. 6 shows a catadioptric projection objective as has been disclosed and described in the document U.S. Pat. No. 6,995,833 B2. For a complete description of the projection objective 20, reference is made to that document.

The projection objective 20 has a first pupil plane P1 at the object or reticle side which is suitable for the arrangement of an aperture diaphragm AP as has been described with reference to FIG. 4.

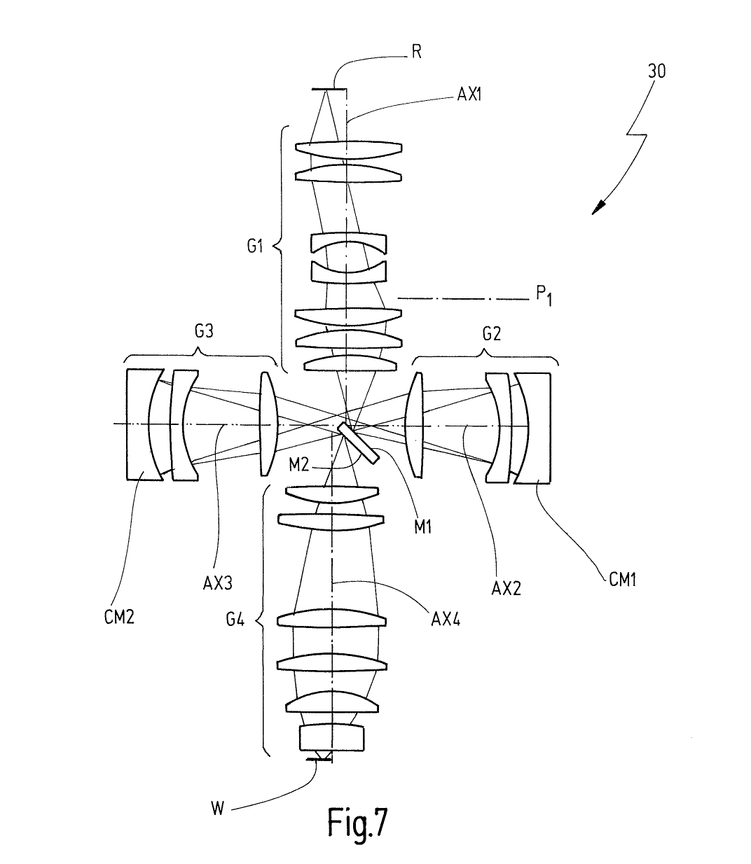

FIG. 7 shows a projection objective 30 as has been disclosed and described in the document JP 2004 317534 A.

As a diaphragm position for an aperture diaphragm AP as described with reference to FIG. 4, the objective part at the reticle side can also be used here which has a first pupil plane P₁.

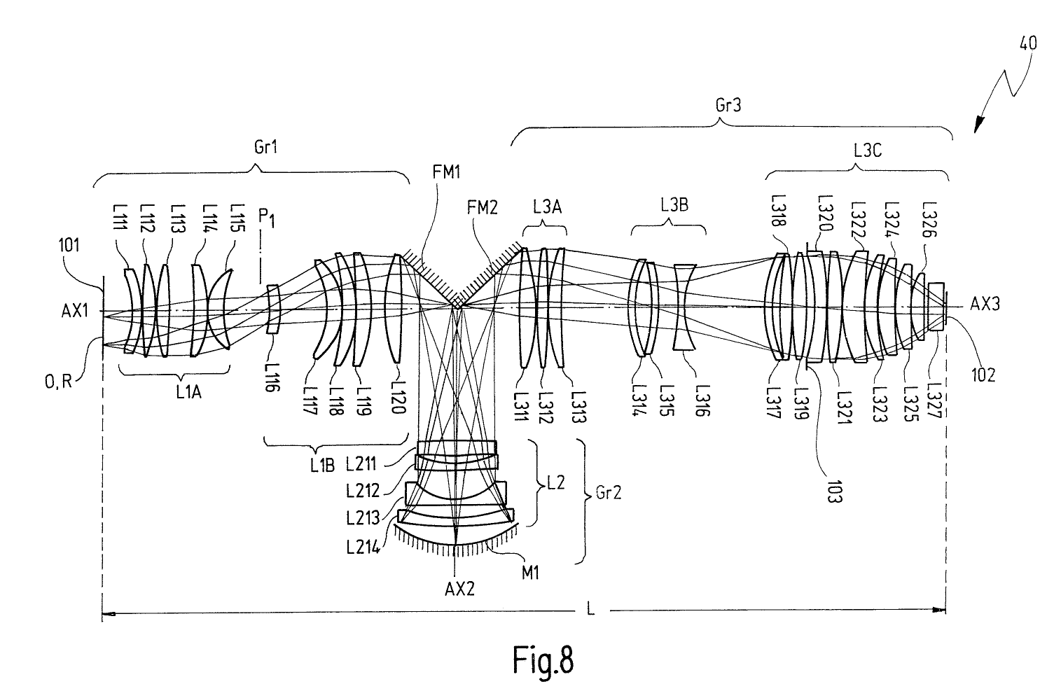

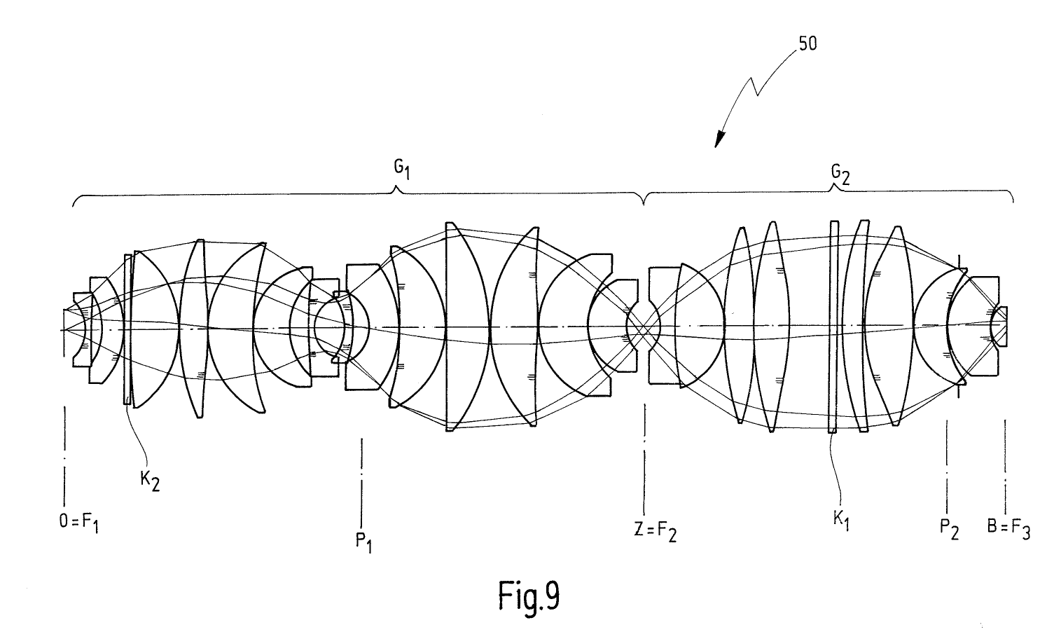

FIG. 8 shows a further projection objective 40 in which the disclosure can be used. The projection objective 40 has also been disclosed and described in the document U.S. Pat. No. 6,995,833 B2, already mentioned above, to which reference is made for further explanations. This projection objective 40, too, has a pupil plane P₁ in the objective part at the reticle side, in or in the immediate vicinity of which an aperture diaphragm AP can be arranged as has been described with reference to FIG. 4.

Whereas the projection objectives 10 to 40 hitherto described are catadioptric projection objectives, the disclosure can also be used with a dioptric projection objective as is shown for the projection objective 50 in FIG. 9. In this case, a position in or in the immediate vicinity of the pupil plane P₁ can be considered as diaphragm position but the design of the optics must slightly be changed there in order to avoid an installation space conflict between the adjoining refractive elements.

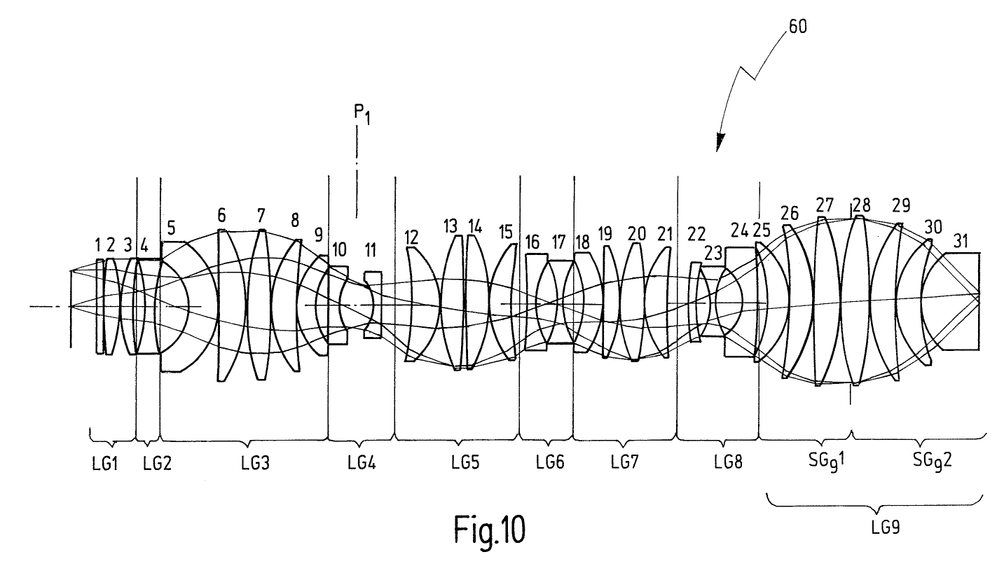

A further dioptric projection objective 60 which has been disclosed and described in US 2006/0056064 A1 is shown in FIG. 10. In the case of this projection objective, the aperture diaphragm as has been described with reference to FIG. 4 can be arranged in the area of the pupil plane P₁ at the reticle side.

What is claimed is:

1. A projection objective configured to image a pattern in an object plane onto an article in an image plane, the projection objective comprising:
an arrangement of optical elements between the object plane and the image plane, the arrangement of optical elements having a first pupil plane at a reticle side of the projection objective and a second pupil plane;
an aperture diaphragm having a variable diaphragm aperture, the aperture diaphragm being configured so that, during use of the projection objective, the aperture diaphragm is traversed only once by imaging light; and
a pupil filter in immediate vicinity of the aperture diaphragm,
wherein the aperture diaphragm is within the arrangement of optical elements at least optically close to the first pupil plane, and the projection objective is configured to be used in microlithography.

2. The projection objective of claim 1, wherein a Petzval sum between the object plane of the projection objective and the aperture diaphragm plane is undercorrected.

3. The projection objective of claim 1, wherein the diaphragm aperture is variable on a curved surface.

4. The projection objective of claim 3, wherein the curved surface is concave to the object plane of the projection objective.

5. The projection objective of claim 1, wherein the arrangement of optical elements comprises two refractive elements, and the aperture diaphragm is located between the two refractive elements.

6. The projection objective of anyone of claim 1, wherein a reticle is located in object plane, and the first pupil plane is a pupil plane of the projection objective that is closest to the reticle.

7. The projection objective of claim 1, wherein the pupil filter is removable from the projection objective.

8. The projection objective of claim 3, wherein the pupil filter is within a cavity spanned by the curved surface.

9. The projection objective of claim 3, wherein a relation 0.5<|h/r|<0.1 applies to the curved surface, where h is half a diameter of the aperture diaphragm with a full numeric aperture and r is a radius of the curved surface.

10. The projection objective of claim 1, wherein the arrangement of optical elements is catadioptric and has at least one concave mirror.

11. The projection objective of claim 1, wherein the arrangement of optical elements is dioptric.

12. A system, comprising:
the projection objective of claim 1,
wherein the system is a microlithography system.

13. The system of claim 12, further comprising a reticle at the object plane.

14. The system of claim 13, further comprising a wafer at the image plane.

15. A projection objective configured to image a pattern in an object plane onto an article in an image plane, the projection objective comprising:
an arrangement of optical elements between the object plane and the image plane, the arrangement of optical elements having first and second pupil planes, the first pupil plane being closer to the object plane of the projection objective along an optical path of the projection objective than the second pupil plane;
an aperture diaphragm having a variable diaphragm aperture, the aperture diaphragm being configured so that, during use of the projection objective, the aperture diaphragm is traversed only once by imaging light; and
a pupil filter in immediate vicinity of the aperture diaphragm,
wherein the aperture diaphragm is within the arrangement of optical elements at least optically close to the first pupil plane, and the projection objective is configured to be used in microlithography.

16. The projection objective of claim 15, wherein a Petzval sum between the object plane of the projection objective and the aperture diaphragm plane is undercorrected.

17. The projection objective of claim 15, wherein the diaphragm aperture is variable on a curved surface.

18. The projection objective of claim 17, wherein the curved surface is concave to the object plane of the projection objective.

19. The projection objective of claim 15, wherein the arrangement of optical elements comprises two refractive elements, and the variable aperture diaphragm is located between the two refractive elements.

20. The projection objective of anyone of claim 15, wherein a reticle is located in object plane, and the first pupil plane is a pupil plane of the projection objective that is closest to the reticle.
